(19) United States
(12) Patent Application Publication
(10) Pub. No.: US 2006/0060459 A1
(43) Pub. Date: Mar. 23, 2006

(54) Operation device

(75) Inventor: Kazuo Kaneo, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/230,334

(22) Filed: Sep. 15, 2005

(30) Foreign Application Priority Data
Sep. 22, 2004 (JP) 2004-274290

(51) Int. Cl. H01H 57/00

(52) U.S. Cl. 200/181

(57) ABSTRACT

In an operation plane, a low friction layer, which has a lower friction coefficient than an elastic member, is formed on the elastic member to overlap it, portions of the low friction layer corresponding to contact points are removed, and concave portions are formed. A surface of the elastic member is exposed to the concave portions and the concave portions have a higher friction coefficient than the other portion. Accordingly, when an operator moves his finger on the concave portions, the operator can feel a predetermined friction resistance and recognize through his finger that the contact points are definitely pressed.

### BACKGROUND OF THE INVENTION

1. Field of the Invention

The present invention relates to a pressing operation device mounted on a small electronic apparatus, and in particular, to an operation device capable of easily recognizing whether a location of a contact point is pressed.

2. Description of the Related Art

FIG. 6 is a cross-sectional view illustrating a conventional operation device.

If an operator puts his finger F on an operation plane 101 and presses his finger F on a corresponding portion of the operation plane 101 located right above a contact point 102A in the Z2 direction of FIG. 6, only a pressed portion of an elastic member 103 is deformed to be locally bent downward. In addition, as the elastic member 103 is deformed, a reinforcing member 104 is also deformed to be bent downward, so that only a protrusion 105a is pressed. As the protrusion 105a is pressed downward, an upper sheet 106 is deformed to be bent downward, so that an upper conductive portion 106a of the upper sheet 106 comes into contact with a lower conductive portion of a lower sheet 107 to become in an electrically conductive state. Thereby, it can be detected that the contact point 102A has been pressed.

Further, if the operator slides his finger F on the operation plane 101 in the X1 direction of FIG. 6 while pressing on the operation plane 101, an upper conductive portion 106b of the upper sheet 106 and a lower conductive portion 107b of the lower sheet 107 (corresponding to a contact point 102B) come into contact with each other, and then an upper conductive portion 106c and a lower conductive portion 107c (corresponding to a contact point 102C) come into contact with each other. As such, the contact points each become in an input state in a sequential manner.

Japanese Unexamined Patent Application Publication No. 2001-175393 discloses an OHP projection-type electronic calculator.

FIG. 7 is a cross-sectional view illustrating a key sheet portion of an OHP projection-type electronic calculator.

A surface of the key sheet 202 opposite to the conductor 201 is subjected to a surface machining process 203 over a predetermined range of the surface.

In such a key structure, by pressing a portion of the key sheet 202 subjected to the surface machining process 203, the conductor 201 is connected to two adjacent transparent electrodes 204, and as a result, electric signals flow therethrough to perform the key input operation.

On the other hand, in the conventional operation device 100, the operation plane 101 is generally formed to have a planar shape using a material having a low friction coefficient. This is to improve operability so that when the operator slides his finger F on the operation plane 101, the finger F can move smoothly.

However, in order to press the respective contact points in a sequential manner, when the operator slides his finger F on the operation plane 101, if the operation plane 101 has a uniform friction coefficient, it is not possible for the operator to recognize through the sense of contact of his finger F whether the respective contact points are sequentially pressed.

The operation device 100 is mounted on a small electronic apparatus, such as a mobile phone. In addition, in the operation device 100, visual display, which can recognize the locations of the contact points, is not made on the operation plane 101. For this reason, if the operator can recognize the locations of the contact points using only the sense of contact of the finger F, the operability can be improved.

In addition, according to the technology disclosed in Japanese Unexamined Patent Application Publication No. 2001-175393, since a pressing operation is performed while viewing a code display unit on the key sheet 202, it assumes as an object and an effect thereof that performing the surface machining process 203 of the key sheet 202 allows codes of the code display unit to be clearly recognized. Accordingly, as in the operation device 100 shown in FIG. 6, it is not possible for the operator to slide his finger F on the operation plane 101 so as to recognize portions of the code display unit through the sense of contact of the finger F.

### SUMMARY OF THE INVENTION

The present invention is designed to solve the above-mentioned problems, and it is an object of the invention to provide an operation device capable of recognizing whether a location of a contact point is pressed and of improving operability as compared to a related art.

According to an aspect of the invention, an operation device includes a soft elastic body having an operation plane at a surface side thereof; and a plurality of contact points provided at the back side of the elastic body so as to be opposite to the operation plane. When an operation body slides on the operation plane while pressing on the operation plane, the elastic body locally-deforms continuously, so that the contact points each become in an input state in a sequential manner. Further, friction coefficients of portions of the operation plane corresponding to at least some of the contact points are different from friction coefficients of the other portions of the operation plane.

As such, since the friction coefficients of portions of the operation plane corresponding to at least some of the contact points are different from the friction coefficients of the other portions of the operation plane, when the operation body slides on the operation plane, the portions corresponding to the contact points and the other portions of the operation plane other than the portions corresponding to the contact points can be recognized through the sense of contact applied to the operation body, so that it is possible to provide an operation device having higher operability than the conventional operation body.

Preferably, the friction coefficients of portions of the operation plane corresponding to at least some of the contact points are higher than the friction coefficients of the other portions of the operation plane.

As such, since the friction coefficients of the other portions of the operation plane other than the portions of the operation plane corresponding to the contact points is lower than the friction coefficients of the portions corresponding to the contact points, the operation body can slide smoothly on the operation plane, and the portions, having high coefficients, which correspond to the contact points, can be easily recognized through the sense of contact applied to the operation body.

Preferably, the portions of the operation plane corresponding to at least some of the contact points and the other portions of the operation plane are respectively formed of materials having different friction coefficients.

As such, it is possible to form an operation plane that has portions each having a different friction coefficient in a simple structure.

Preferably, a low friction layer having a lower friction coefficient than the elastic body is provided on the surface of the elastic body, and at the portions of the operation plane corresponding to at least some of the contact points, the low friction layer is not formed to expose the surface of the elastic body.

Preferably, a low friction layer having a lower friction coefficient than the elastic body is provided on the entire surface of the elastic body, and a high friction layer having a higher friction coefficient than the low friction layer is formed at the portions of the operation plane corresponding to at least some of the contact points.

As a result, with the simple structure, the friction coefficients of the portions corresponding to the contact points can increase and the friction coefficient at the location other than the portions corresponding to the contact points can decrease.

Preferably, the contact points are dotted in a matrix. In this case, even when the operation body is not located at a portion corresponding to a location of the contact point in which an operator desires to press, the operation body can be easily guided to the portion corresponding to the location of the contact point which the operator desires to press, through the sense of contact of the operation plane applied to the operation body. As a result, it is possible to confidently move the operation body to the portion corresponding to the location of the contact point in which the operator desires to press. Therefore, it is possible to ensure excellent operability.

### BRIEF DESCRIPTION OF THE DRAWINGS

FIG. 1 is a plan view illustrating an operation device of the invention;

FIG. 2 is a cross-sectional view taken along the line II-II of FIG. 1 to illustrate a first embodiment of the invention;

FIG. 3 is a view explaining the operation of an operation device according to the first embodiment of the invention;

FIG. 4 is a cross-sectional view illustrating a modification of the operation device according to the first embodiment of the invention, which is similar to FIG. 2;

FIG. 5 is a plan view illustrating an operation device according to a second embodiment of the invention;

FIG. 6 is a cross-sectional view illustrating a conventional operation device; and

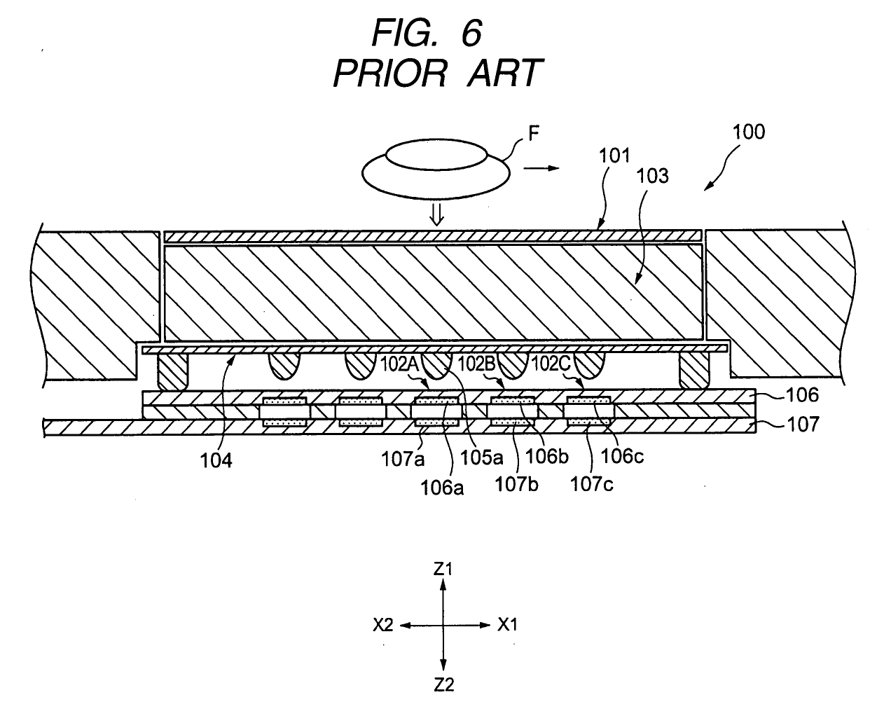

FIG. 7 is a cross-sectional view illustrating a key sheet portion of an OHP projection-type electronic calculator.

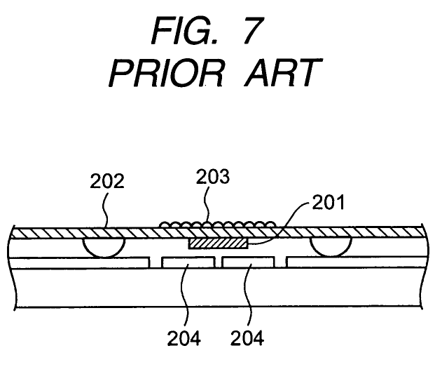

### DESCRIPTION OF THE PREFERRED EMBODIMENT

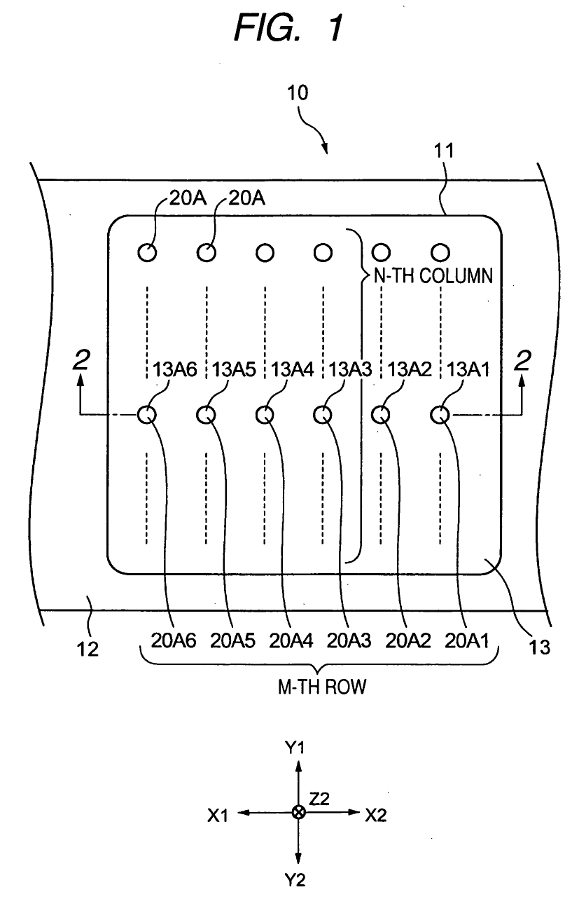

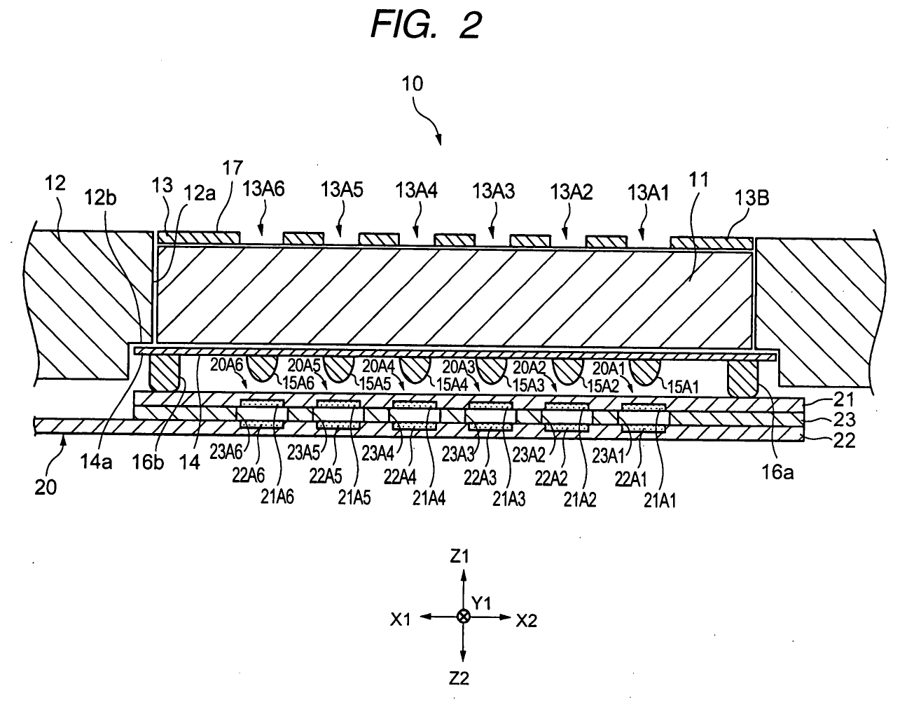

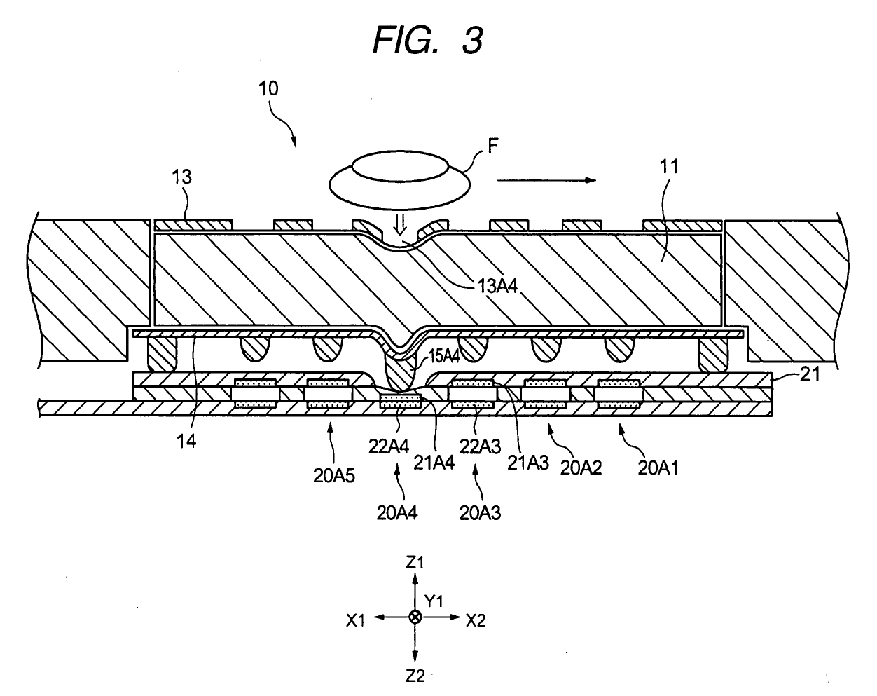

FIG. 1 is a plan view illustrating an operation device of the invention, FIG. 2 is a cross-sectional view taken along the line II-II of FIG. 1 and illustrates a first embodiment of the invention, and FIG. 3 is a view explaining the operation of an operation device according to the first embodiment of the invention.

As shown in FIG. 1, an operation device 10 has a planar shape with predetermined sizes in a direction of X1-X2 (an X direction, that is, a first direction) and a direction of Y1-Y2 (a Y direction, that is, a second direction). The operation device 10 has an elastic member (an elastic body) 11 with a planar shape.

As shown in FIG. 2, a membrane sheet 20 is provided at a back surface side (the side of Z2 in FIG. 2) of the elastic member 11. In the membrane sheet. 20, a plurality of contact points 20A are provided in a matrix at a predetermined pitch along the X direction and the Y direction. Among the plurality of contact points 20A, contact points shown in FIG. 2 are sequentially referred to as contact points 20A1, 20A2, 20A3, 20A4, 20A5, and 20A6 in the direction from the side of X2 to the side of X1.

The operation device 10 according to the present embodiment is mounted on an electronic apparatus, for example, a remote controller, such as a DVD recorder or the like, and is used as an operation device to select a desired menu from menu display having a plurality of menus televised on a television screen.

In the operation device 10, an assembling hole 12a is formed in a case 12 constituting the electronic apparatus, and an operation plane 13 provided on a surface of an elastic member 11 (surface at the Z1 side) from the assembling hole 12a is exposed such that it is almost on the same plane as a surface of the case 12.

The elastic member 11 is formed of an elastically deformable soft material. A low friction layer 17, which has a lower friction coefficient than the surface of the elastic member 11, is formed on the surface of the elastic member 11 so as to overlap the surface. In the low friction layer 17, portions of the operation plane 13 corresponding to contact points 20A1 to 20A6 are removed, and the surface of the elastic member 11 is exposed to concave portions 13A1 to 13A6 formed by removing the portions corresponding to the contact points 20A1 to 20A6.

A reinforcing member 14 is formed on a back surface of the elastic member 11 to overlap it. The reinforcing member 14 has a film shape and protrudes more toward the outer side than the operation plane 13 (the direction of an X-Y plane). A portion protruding more toward the outer side than the elastic member 11 and the operation plane 13 forms a flange portion 14a. The flange portion 14a is provided at peripheries of the elastic member 11 and the operation plane 13. As such, if the flange portion 14a is formed, when the operation device 10 is mounted on the case 12 and the operation device 10 is inserted into the assembling hole 12a from the back side of the case 12, the flange portion 14a is locked to a stepped locking portion 12b formed in the case 12. As a result, it is prevented that the operation device 10 is detached from the case 12.

Hemispheric protrusions 15A1, 15A2, 15A3, 15A4, 15A5, and 15A6 are formed on the back surface of the reinforcing member 14 such that they are located right above the contact points 20A1 to 20A6.

In addition, the reinforcing member 14 is not limited to a case in which it is formed of one sheet having a film shape. That is, the reinforcing member 14 may be fixed on the back surface of the elastic member 11 and another member having a film shape, on which the protrusions 15A1 to 15A6 are provided, may be fixed on the reinforcing member 14. At this time, the reinforcing member 14 and another member having the film shape may be formed of the same resin, such as a PET resin.

A supporting portion 16a is formed at the side of X2 in the drawing where the protrusion 15A1 is formed, and a supporting portion 16b is formed at the side of X1 in the drawing where the protrusion 15A6 is formed. The protrusions 15A1 to 15A6 and the supporting portions 16a and 16b are formed of an ultraviolet curable resin by a printing method, but are not limited thereto.

Although not shown, adhesive layers each having an adhesive property are formed on surfaces of the supporting portions 16a and 16b and are adhesively fixed on the surface of the membrane sheet 20.

The membrane sheet 20 includes an upper sheet 21, a lower sheet 22, and a spacer 23, and the upper and lower sheets 21 and 22 are provided opposite to each other. The spacer 23 having a sheet shape is inserted between the upper sheet 21 and the lower sheet 22 to adhesively fix them. The upper sheet 21, the lower sheet 22, and the spacer 23 are formed of flexible materials, such as a PET resin or polyimide resin, and are adhesively fixed. Alternatively, the upper and lower sheets 21 and 22 may be formed of the PET resin, the spacer 23 may be formed of an adhesive layer made of an adhesive, and they may be adhesively fixed.

In the upper and lower sheets 21 and 22, a circular upper conductive portion 21A1 and a circular lower conductive portion 22A1 are provided opposite to each other at a location opposite to the protrusion 15Al. In the spacer 23, a through-hole 23A1, in which the conductive portions 21A1 and 22A1 are exposed and which has a higher diameter than the conductive portions 21A1 and 22A1, is formed. The upper conductive portion 21A1 and the lower conductive portion 22A1, which are disposed opposite to each other to constitute a pair, form the contact point 20A1.

Similar to the protrusion 1SA1, with respect to the protrusions 15A2 and 15A6, upper conductive portions 21A2 to 21A6, lower conductive portions 22A2 to 22A6, and through-holes 23A2 to 23A6 are formed, respectively. In addition, the upper conductive portion and the lower conductive portion, which are disposed opposite to each other to constitute a pair, form each of the contact points 20A2 to 20A6.

In the lower sheet 22, linear conductive patterns (not shown) and one common conductive pattern (not shown) extend from the lower conductive portions 22A1 to 22A6 so as to overlap each other. The common conductive pattern is formed to extend from the lower sheet 22 to the upper conductive portions 21A1 to 21A6 of the upper sheet 21. In addition, the conductive patterns and the common conductive pattern are formed to extend up to a control unit (not shown). The upper conductive portions 21A1 to 21A6, the lower conductive portions 22A1 to 22A6, and the conductive patterns and the common conductive pattern are all formed of a metal material, such as copper or silver.

When a current is supplied to the common conductive pattern, for example, the upper conductive portion 21A3 and the lower conductive portion 22A3 come into contact with each other to generate a current. If the generated current is output from the conductive pattern formed in the lower conductive portion 22A3, the control unit detects that the contact point 20A3 is pressed. In this way, similar to the contact point 20A3, the control unit can detect whether contact points are pressed with respect to the other contact points 20A1, 20A2, 20A4, 20A5, and 20A6.

The elastic member 11 of the invention is preferably formed of silicon rubber. The silicon rubber can be light weight and locally bent as compared to high-density polyethylene or polypropylene. In addition, the material of the elastic member 11 is not limited to the silicon rubber, but other rubber-based elastic members may be used.

As described above, the reinforcing member 14, which is formed of the film-shaped PET resin or polypropylene resin, is provided on the back surface of the elastic member 11 formed of the silicon rubber, so that the twist can be prevented without damaging the bending deformation of the elastic member 11 in a Z direction (the direction of Z1-Z2).

The low friction layer 17 is formed of an inorganic filler, specifically, a silicon resin containing silica particles. However, the forming material of the low friction layer 17 is not limited to the silicon resin containing the silica particles, but other materials may be used. For example, any other material, in which a force required to move the operation body on the operation plane 13 is weaker than a pressing force required to input the contact point 20A, may be used.

Next, the operation of the operation device 10 of the invent ion will be described.

As shown in FIG. 3, when an operator puts his finger (operation body) F on the operation plane 13, the contact points 20A3, 20A4, and 20A5 are covered. At this time, if the concave portion 13A4 corresponding to a portion formed right above the contact point 20A4 is pressed by applying a light weight, the elastic member 11 is locally bent downward. In addition, as the elastic member 11 is deformed, the reinforcing member 14 is also bent downward, so that only the protrusion 15A4 is pressed. The protrusion 15A4 moves downward, so that the upper sheet 21 is bent downward. As a result, the upper conductive portion 21A4 and the lower conductive portion 22A4 come into contact with each other to become in an electrically conductive state, and the contact point 20A4 becomes in an input state. Therefore, the control unit detects that the contact point 20A4 is pressed.

In addition, if the operator moves his finger F in an X2 direction of the drawing, the elastic member 11 is locally deformed continuously, the respective contact points become in a contact state in the order of the contact point 20A3→the contact point 20A2→the contact point 20A1, and input states of the respective contact points are sequentially changed. Therefore, the control unit detects that the respective contact points are sequentially pressed, and the menu display can be scrolled rightward on the television screen.

In the same manner, if the operator moves his finger F in the X1, Y1, and Y2 directions of the drawing, the contact points becomes in a contact state sequentially along the moving direction of the finger F, and the menu display can be scrolled leftward, upward, and downward on the television screen.

In the present invention, the low friction layer 17 of the portions, of the operation plane 13, corresponding to the contact points 20A1 to 20A6 is removed to form the concave portions 13A1 to 13A6, and the surface of the elastic member 11 having a higher friction coefficient than the low friction layer 17 is exposed to the concave portions 13A1 to 13A6. That is, the concave portions 13A1 to 13A6, and the other portions 13, in which the concave portions 13A1 to 13A6 are not provided, have different friction coefficients. In addition, in the concave portions 13A1 to 13A6 and the other portion 13B, friction resistances applied to the finger F are different. Specifically, the friction resistance applied to the finger F becomes higher in the case in which the finger F moves on the concave portions 13A1 to 13A6 than in the case in which the finger F moves on the other portion 13B. For this reason, the sense of contact applied to the finger F when the finger F slides on the concave portions 13A1 to 13A6 is different from the sense of contact applied to the finger F when the finger F slides on the other portion 13B. In a case in which the finger F slides on the concave portions 13A1 to 13A6, since the friction resistance is high, the operator feels that it is difficult for his finger to slide. On the other hand, in a case in which the finger slides on the other portion 13B, since the friction resistance is low, the operator feels that it is easy for his finger to slide.

In the present embodiment, since the contact points 20A are dotted in a matrix, if the operation plane 13 has a uniform friction resistance as in the conventional art, locations of the contact points 20A cannot be recognized through the sense of contact of the finger F. As a result, since an amount of time is required in order that the operator moves his finger F to a location of the contact point 20A which the operator desires to press, the operability becomes deteriorated. However, according to the invention, the portions of the operation plane 13 corresponding to the contact points 20A dotted in a matrix have a higher friction resistance than the other portion 13B. For this reason, if the operator moves his finger F along the operation plane 13, the operator can easily guide his finger F to the location of the contact point 20A which the operator wants to press, through the sense of contact of his finger F on the operation plane 13. In addition, in the case in which the operator desires to move his finger F straightly along the respective contact points 20A1 to 20A6, when the operator moves his finger F on the operation plane 13, the operator can guide his finger F such that the concave portions 13A1 to 13A6 each having a high friction resistance are pressed by his finger F. For this reason, when the concave portions 13A1 to 13A6 are not pressed, the operator can recognize the difference of a friction resistance applied to the finger F, and the operator can change the moving direction or moving location of his finger F such that the concave portions 13A1 to 13A6 are pressed. As a result, the operator can move his finger F such that the concave portions 13A1 to 13A6 are definitely pressed by his finger F and can recognize through his finger F whether the contact points 20A1 to 20A6 are definitely pressed.

In the present invention, since the elastic member 11 is formed of the silicon rubber, there is a possibility that when the elastic member 11 is pressed, it is excessively deformed, and thus the operability becomes deteriorated. However, since the reinforcing member 14 is fixed on the elastic member 11 and the amount of deformation of the elastic member 11 is properly controlled, it is possible to prevent the operability from deteriorating.

Further, in order that the portions of the operation plane 13 corresponding to the contact points 20A1 to 20A6 and the other portion 13B have different friction coefficients, the portions of the low friction layer 17 corresponding to the contact points 20A1 to 20A6 are removed to form the concave portions 13A1 to 13A6. However, in the invention, a method of forming the concave portions 13A1 to 13A6 is not limited to a method of removing portions of the low friction layer 17, but the other portion 13B may be provided at the location of the surface of the elastic member 11 shown in FIG. 2 to form the concave portions 13A1 to 13A6.

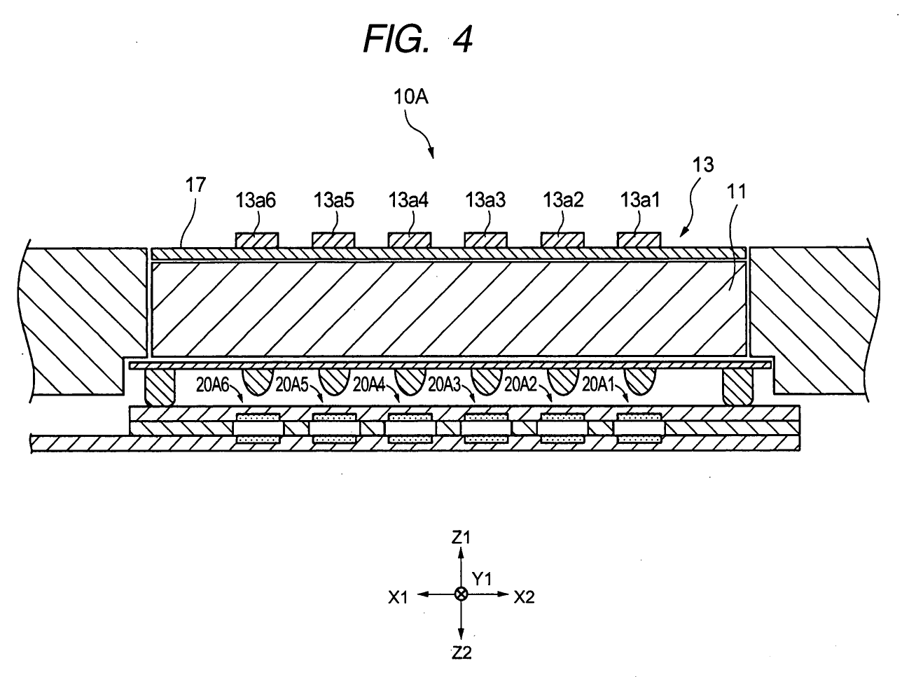

FIG. 4 is a cross-sectional view illustrating a modification of the operation device according to the first embodiment of the invention, which is similar to FIG. 2.

In FIG. 4, the same constituent elements as in the operation device 10 shown in FIG. 2 are denoted by the same reference numerals and the description thereof will be omitted.

An operation device 10A according to the modification is different from the operation device 10 in that a low friction layer 17 is formed on the entire surface of an elastic member 11, and convex high friction layers 13a1 to 13a6 are formed on portions of the low friction layer 17 corresponding to contact points 20A1 to 20A6.

The high friction layers 13a1 to 13a6 are formed of a material, such as the silicon rubber for forming the elastic member 11, which has a higher friction coefficient than the low friction layer 17.

Even in the modification, of the operation plane 13, surfaces of the high friction layers 13a1 to 13a6, and a surface of the low friction layer 17 in which the high friction layers 13a1 to 13a6 are not provided, have different friction coefficients. Therefore, friction resistances applied to the finger F are also different. Specifically, the friction resistance applied to the finger F becomes higher in the case in which the finger slides on the high friction layers 13a1 to 13a6 than in the case in which the finger slides on the low friction layer 17. For this reason, the sense of contact applied to the finger F when the finger F slides on the high friction layers 13A1 to 13A6 is different from the sense of contact applied to the finger F when the finger F slides on the low friction layer 17. In the case in which the finger F slides on the high friction layers 13a1 to 13a6, since the friction resistance is high, the operator feels that it is difficult for his finger to slide. On the other hand, in the case in which the finger slides on the low friction layer 17, since the friction resistance is low, the operator feels that it is easy for his finger to slide.

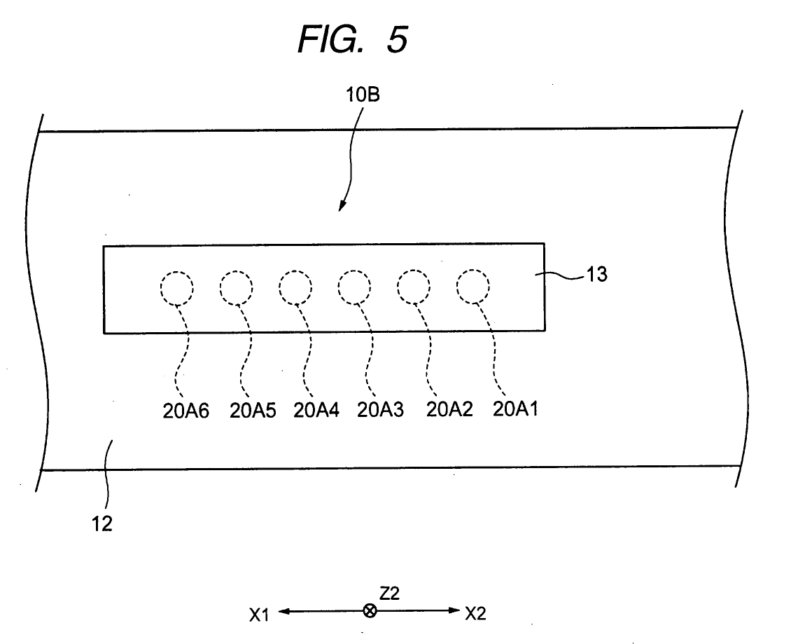

FIG. 5 is a plan view illustrating an operation device according to a second embodiment of the invention, which is similar to FIG. 1.

In the operation device shown in FIG. 5, the same constituent elements as in the operation devices 10 and 10A shown in FIGS. 1, 2 and 4 are denoted by the same reference numerals and the description thereof will be omitted.

The operation device 10B according to the second embodiment is different from the operation devices 10 and 10A in that it has a planar elastic member having a shape elongated in the X direction of the drawing. Specifically, in the operation device 10B, only a planar shape thereof is different from those of the operation devices 10 and 10A, and the sectional structure or the other structure is the same as those of the operation devices 10 and 10A. In addition, the operation of the operation device 10B is the same as those of the operations devices 10 and 10A.

The operation device 10B is mounted on a remote controller, such as, for example, a camera, a mobile phone or the like.

In the present embodiment, similar to the operation devices 10 and 10A, concave portions 13A1 to 13A6 or convex high friction layers 13a1 to 13a6, which have a higher friction coefficient than the other portion and to which a surface of an elastic member 11 is exposed, are provided at locations of an operation plane 13 opposite to contact points 20A1 to 20A6. For this reason, if an operator moves a finger F on an operation plane 13 in order to sequentially make the contact points 20A1 to 20A6 become in a contact state, the operator can feel the difference between friction resistances through his finger F to move his finger F to a desired location. In addition, the operator can recognize confidently whether the location of his finger F changes. As a result, the operator can recognize through his finger F whether the contact points 20A1 to 20A6 are definitely pressed.

Further, it is not necessary that the concave portions or the high friction layers be all provided at the locations corresponding to the contact points. For example, as shown in FIG. 1, the concave portions or the high friction layers may be provided at portions only corresponding to contact points through which horizontal scrolling of the menu display is performed and are arranged in the M-th row and at portions only corresponding to contact points through which vertical scrolling of the menu display is performed and are arranged in an N-th row.

In the above-mentioned embodiments, the portions of the operation plane corresponding to the locations of the contact points are formed of a material having a higher friction coefficient than the other portions thereof. However, to the contrary, the portions of the operation plane corresponding to the locations of the contact points may be formed of a material having a lower friction coefficient than the other portions thereof. However, it is preferable that the other portions have a lower friction coefficient than the portions corresponding to the locations of the contact points. The reason is that the operator can slide his finger F smoothly on the operation plane 13, and can easily recognize the locations of the contact points, which are formed of a material having a high friction coefficient and are dotted.

In the present invention, in the case in which the width of the finger F is higher than the gap between contact points when the operator presses his finger F on the operation plane 13, the plurality of contact points may become in input states simultaneously. However, when three contact points become in input states simultaneously, for example, a control on the simultaneous input can be performed such that only an input of a corresponding contact point becomes valid and inputs of the other contact points become invalid. In the operation device according to the invention, the location of the contact point can be recognized through the sense of contact of the operation body, so that it is possible to ensure excellent operability as compared to the conventional operation device.

1. An operation device comprising:
a soft elastic body having an operation plane at a surface side thereof; and
a plurality of contact points provided at a back side of the elastic body so as to be opposite to the operation plane,
wherein, when an operation body slides on the operation plane while pressing on the operation plane, the elastic body locally-deforms continuously, so that the contact points each become in an input state in a sequential manner, and
friction coefficients of portions of the operation plane corresponding to at least some of the contact points are different from friction coefficients of the other portions of the operation plane.

2. The operation device according to claim 1,
wherein the friction coefficients of portions of the operation plane corresponding to at least some of the contact points are higher than the friction coefficients of the other portions of the operation plane.

3. The operation device according to claim 1,
wherein the portions of the operation plane corresponding to at least some of the contact points and the other portions of the operation plane are respectively formed of materials having different friction coefficients.

4. The operation device according to claim 3,
wherein a low friction layer having a lower friction coefficient than the elastic body is provided on the surface of the elastic body, and
at the portions of the operation plane corresponding to at least some of the contact points, the low friction layer is not formed to expose the surface of the elastic body.

5. The operation device according to claim 3,
wherein a low friction layer having a lower friction coefficient than the elastic body is provided on the entire surface of the elastic body, and
a high friction layer having a higher friction coefficient than the low friction layer is formed at the portions of the operation plane corresponding to at least some of the contact points.

6. The operation device according to claim 1,
wherein the contact points are dotted in a matrix.
